(19) United States
(12) Patent Application Publication
(10) Pub. No.: US 2023/0413182 A1
(43) Pub. Date: Dec. 21, 2023

(54) WIRELESS DEVICE FOR DETERMINING AN ENERGY PARAMETER AND RELATED METHOD

(71) Applicant: Sony Group Corporation, Tokyo (JP)

(72) Inventor: Peter EXNER, Malmo (SE)

(21) Appl. No.: 18/201,434

(22) Filed: May 24, 2023

(30) Foreign Application Priority Data
Jun. 9, 2022 (SE) 2250697-6

(51) Int. Cl. H04W 52/06; H04W 52/02

(52) U.S. Cl. CPC H04W 52/06; H04W 52/0261

(57) ABSTRACT

A wireless device includes a memory circuit, processor circuitry, and a wireless interface, and is configured to obtain a cellular parameter indicative of cellular channel quality and determine, based on the cellular parameter, a first energy cost parameter indicative of energy required for performing a communication of data. The wireless device transmits the data. The wireless device obtains a network parameter indicative of a network condition in which the transmission of the data occurred. The wireless device determines, based on the cellular parameter and the network parameter, a second energy cost parameter. The wireless device determines, based on the second energy cost parameter, an update parameter. The wireless device, upon the update parameter meeting a criterion, update the first transmission cost parameter based on the second transmission cost parameter and the cellular parameter.

### CROSS REFERENCE TO RELATED APPLICATIONS

The present application claims priority to Swedish Patent Application No. 2250697-6, filed Jun. 9, 2022, the content of which is incorporated herein by reference in its entirety.

### TECHNICAL FIELD

The present disclosure pertains to the field of wireless communications. The present disclosure relates to wireless devices that may be configured to determine an energy parameter indicative of an amount of energy required for performing a communication of data, and a related method for performing a communication.

### BACKGROUND

Internet of Things (IoT) devices may have a cloud reporting mechanism to report sensed data. As an example, smart trackers in logistics may continuously report the location of tracked goods using some type of cellular connectivity. Depending on the cellular environment and network condition of the tracker, establishing a connection and transmitting data may incur a high transmission energy cost.

### SUMMARY

Power analysers may be bulky and expensive. Therefore, using power analysers to measure the energy required for performing a communication of data might not help minimising transmission energy costs.

Machine learning models may be contemplated to estimate energy levels without falling back on power analysers. However, when deploying any machine learning models, it may be challenging to ensure that the machine learning models are trained and adapted to perform satisfactorily in the environment where a device will function. In other words, pre-training the learning models for all known, foreseen and unforeseen environments can be problematic.

There is a need for wireless devices and methods which may mitigate, alleviate or address the existing shortcomings and may provide for an estimation of the energy required for performing a communication of data which may be continuously adapted to the environment where the wireless device operates.

A wireless device is provided. The wireless device comprises memory circuit, processor circuitry, and a wireless interface. The wireless device is configured to obtain a cellular parameter indicative of cellular channel quality. The wireless device is configured to determine, based on the cellular parameter, a first energy cost parameter indicative of energy required for performing a communication of data. The wireless device may be configured to transmit the data. The wireless device may be configured to obtain a network parameter indicative of a network condition in which the transmission of the data occurred. The wireless device may be configured to determine, based on the cellular parameter and the network parameter, a second energy cost parameter. The wireless device may be configured to determine, based on the second energy cost parameter, an update parameter. The wireless device may be configured to, upon the update parameter meeting a criterion, update the first transmission cost parameter based on the second transmission cost parameter and the cellular parameter.

The wireless device may be advantageous in that it allows for an improved estimation of the amount of energy required for performing a communication of data without the need for a dedicated power analyser. The updated first energy parameter may be adapted to perform satisfactorily in the environment where the device will function. Put another way, the wireless device may be configured, as illustrated herein, to be continuously adapted to local environments by means of the second energy parameter when the criterion regarding the update parameter is met.

The cellular parameter may allow for the determination of the first energy parameter, which is indicative of an amount of energy required for performing a communication of data. Therefore, an estimation of such amount of energy may be achieved even before the data is transmitted.

The combination of the cellular parameter and the network parameter may allow for a determination of the second energy parameter, which is also indicative of the amount of energy required for performing a communication of data. Hence, the estimation of the amount of energy required for performing a communication of data may be refined after the data is transmitted.

The update parameter may be useful to establish a criterion according to which the first energy parameter is updated. When such criterion is met, the wireless device may update the first energy parameter, which is then based not only on the cellular parameter but also on the second energy parameter. The first energy parameter may thus be refined. Such process of refinement may take place without involvement of a server.

A method, performed by a wireless device, may be disclosed. The method comprises obtaining a cellular parameter indicative of cellular channel quality. The method comprises determining, based on the cellular parameter, a first energy parameter indicative of an amount of energy required for performing a communication of data. The method may comprise transmitting the data. The method may comprise obtaining a network parameter indicative of a network condition in which the transmission of the data occurred. The method may comprise determining, based on the cellular parameter and the network parameter, a second energy parameter. The method may comprise, upon an update parameter meeting a criterion, the update parameter being based on the second energy parameter, updating the first energy parameter based on the second energy parameter and the cellular parameter.

The disclosed method performed by the wireless device may be advantageous for the same reasons as set forth for the wireless devices disclosed herein.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example network node, example wireless devices and an example server device according to this disclosure,

FIG. 2 is a block diagram illustrating an example wireless device according to this disclosure, and

FIG. 3 is a flow-chart illustrating an example method, performed by a wireless device, according to this disclosure,

FIG. 4 shows a graph illustrating a mean average error of the amount of energy required for performing a communication of data as indicated by the first energy parameter and the second energy parameter compared to the amount of energy measured by a power analyser.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

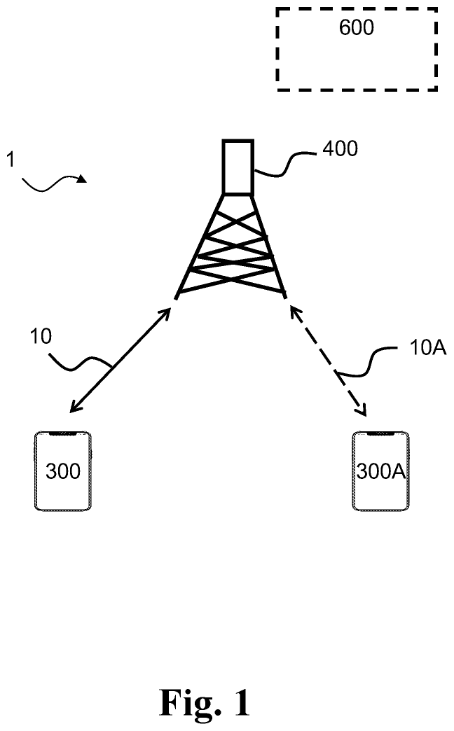

FIG. 1 is a diagram illustrating an example wireless communication system 1 according to this disclosure.

The wireless communication system 1 comprises one or more of: an example network node 400, example wireless devices 300, 300A and an example server device 600.

As discussed in detail herein, the present disclosure relates to a wireless communication system 1 comprising a cellular system, for example, a 3GPP wireless communication system. The wireless communication system 1 may comprise one or more wireless devices 300, 300A and one or more network nodes 400. The wireless communication system 1 may comprise a server device 600.

A network node disclosed herein refers to a radio access network node operating in the radio access network (RAN), such as one or more of: a base station, an evolved Node B, an eNB, a gNB in NR and an access point. In one or more examples, the RAN node is a functional unit which may be distributed in several physical units.

A wireless device may refer to one or more of: a mobile device and a user equipment (UE).

The wireless devices 300, 300A may be configured to communicate with the network node 400 via a wireless link (or radio access link) 10, 10A respectively.

The wireless devices 300, 300A may be configured to communicate with the server device 600, optionally via the network node 400.

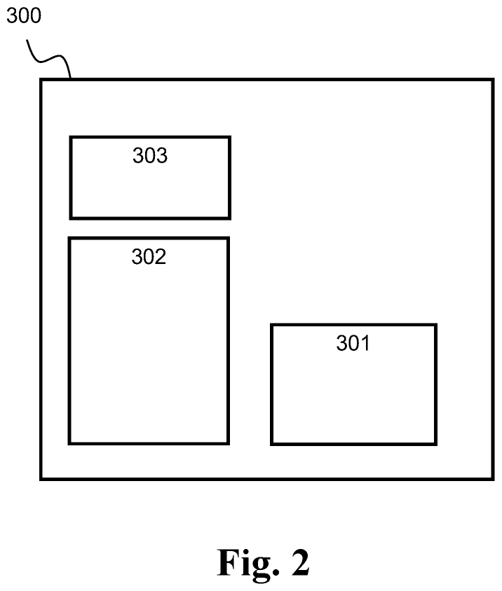

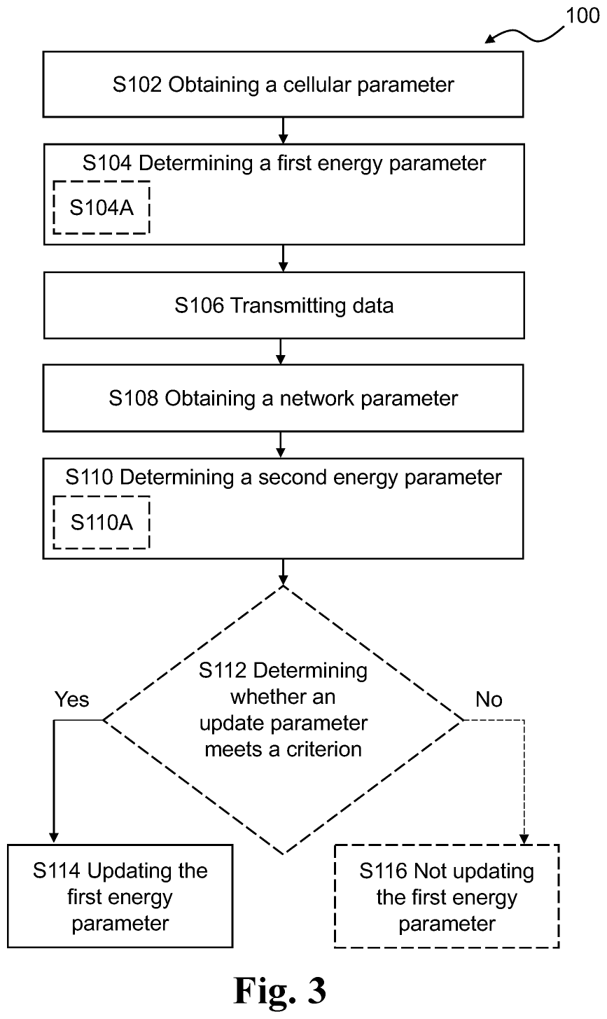

FIG. 2 shows a block diagram of an example wireless device 300 according to the disclosure. The wireless device 300 comprises memory circuitry 301, processor circuitry 302, and a wireless interface 303. The wireless device 300 may be configured to perform any of the methods disclosed herein, such any of the methods of FIG. 3. The wireless device 300 may be seen as a wireless device for an estimation of the energy required for performing a communication of data, for example configured to estimate the energy required for performing a communication of data.

The wireless interface 303 is configured for wireless communications via a wireless communication system, such as a 3GPP system, such as a 3GPP system supporting one or more of: New Radio (NR), Narrow-band IoT (NB-IoT), Long Term Evolution, enhanced Machine Type Communication, LTE-M, millimetre-wave communications (such as millimetre-wave communications in licensed bands or unlicensed bands, such as device-to-device millimetre-wave communications in licensed bands or unlicensed bands), Non-Terrestrial Networks and sidelink communications.

The wireless device 300 is configured to obtain (such as via the processor circuitry 302 and/or wireless interface 303) a cellular parameter indicative of cellular channel quality. Obtaining the cellular parameter may comprise one or more of: detecting, measuring and determining the cellular parameter. The cellular parameter may be obtained once per transmission.

In one or more example wireless devices, the cellular parameter includes one or more of: a signal strength, a signal to noise ratio, a bit error rate, a timing advance, a size of data to be transmitted and any other suitable cellular parameter. The signal to noise ratio may be seen as the signal to noise ratio detected, measured or both detected and measured on the channel between the wireless device and a network node. The bit error rate may be seen as the bit error rate detected, measured or both detected and measured on the channel between the wireless device and a network node. The timing advance may be seen as the timing advance detected and/or measured on the channel between the wireless device and a network node based on the time for a signal to reach the network node from the wireless device. The signal strength may be seen as a Received Signal Strength Indicator (RSSI) associated with a serving cell. The signal strength may be seen as an RSSI associated with a neighbouring cell to the serving cell. The size of data to be transmitted may be a size of a data packet.

The wireless device 300 is configured to determine (such as via the processor circuitry 302), based on the cellular parameter, a first energy parameter indicative of an amount of energy required for performing a communication of data. As used herein, an energy parameter (such as the first energy parameter, the second energy parameter or both the first energy parameter and the second energy parameter) can be seen as a parameter, based on characteristics of a communication cell, representative of an amount of energy required for performing a communication of data. For example, the energy parameter (such as the first energy parameter, the second energy parameter or both the first energy parameter and the second energy parameter) can include a transmission power. The energy parameters may include one or more of: a current parameter, a voltage parameter, a time parameter and any other suitable parameter.

In one or more example wireless devices, the wireless device 300 (such as processor circuitry 302) is configured to determine, based on the cellular parameter, the first energy parameter using a first model. In one or more example wireless devices, the first model provides a correlation between the cellular parameter and an energy measurement measured by a power analyser. In other words, the energy measurement measured by the power analyser may be used to create the first model. Once the first model is created, the first model may be deployed in the wireless device 300 and used to determine the first energy parameter without a need for a power analyser.

In one or more example wireless devices, the first model is based on a feed forward neural network. A feed forward neural network is configured to handle cellular parameter from input node(s), and to process the information in only one direction (such as forward) from the input nodes, through the hidden nodes (if any) and to the output nodes for provision of the first energy parameter. For example, the feed forward neural network does not process in cycles or loops. The hidden nodes may capture and represent signal propagation through buildings and cell station layout.

In one or more example wireless devices, the first model is based on a support vector machine (SVM). A support vector machine is for example, a supervised learning model with associated learning techniques that analyse the cellular parameter for classification and regression analysis. For example, given a set of training examples belonging to one of two categories, an SVM training technique builds a model that assigns new examples to one category or the other, making it a non-probabilistic binary linear classifier and/or using a probabilistic classification setting. For example, SVM maps training examples to points in space so as to maximise the width of the gap between the two categories. For example, SVM can take as input the cellular parameter and provide the first energy parameter. For example, SVM would separates non-linear input parameters by transforming them into a higher-dimensional feature space, such that classes that are then linearly separable represent different energy amounts used in transmissions.

In one or more example wireless devices, the first model is based on a random forest. A random forest technique can be seen as an ensemble learning method for classification, regression and other tasks that operates by constructing a multitude of decision trees at training time from random subsets of training data. In some examples, random decision forests can correct for decision trees' habit of overfitting to their training set, and provide the resulting first energy parameter. For example, for classification tasks, the output of the random forest is the class (which may represent an energy level or amount of energy) predicted by a majority of the multitude of decision trees, based on the input being the cellular parameter. For example, for regression tasks, the mean or average prediction of the individual trees is returned as the first energy parameter based on the cellular parameter.

In one or more example wireless devices, the first model is based on a feed forward neural network and a support vector machine. In one or more example wireless devices, the first model is based on a feed forward neural network and a random forest. In one or more example wireless devices, the first model is based on a support vector machine and a random forest. In one or more example wireless devices, the first model is based on a feed forward neural network, a support vector machine and a random forest. The first model can be seen as a Machine Learning (ML) technique.

It may be advantageous to select the first model based on the wireless device performance capabilities, such as computational capability. Random forest may be particularly suitable as a first model for wireless devices having constrained capabilities, such as constrained computational resources. Other models based on clustering and boosting algorithms may also be appropriate as first model.

The wireless device 300 is configured to transmit (such as via the processor circuitry 302 and/or wireless interface 303) the data. For example, the wireless device 300 transmits the data over the channel and/or over the network. In one or more examples, the data can include user data and/or control signalling.

The wireless device 300 is configured to obtain (such as via the processor circuitry 302 and/or wireless interface 303) a network parameter indicative of a network condition in which the transmission of the data occurred. Put another way, a network parameter can be seen as a parameter representative of the network data transmission conditions.

As used herein, “network condition in which the transmission of the data occurred” may be seen as one or both of: a network condition for the entire duration of a data transmission and a network condition during a part of the data transmission, such as a network condition at an instant of the data transmission.

In one or more example wireless devices, the at least one network parameter comprises one or more of: a duration of transmission of the data, a number of retransmissions of the data, a throughput parameter, an uplink quality of transmission of the data, a number of transport blocks (TBs) received with cyclic redundancy check (CRC) error, a transmitting or receiving Modulation and Coding Scheme (MCS) parameter and any other suitable network parameter. The number of retransmissions may occur due to non-acknowledgment of data (e.g., NACK of hybrid automatic repeat request). The throughput parameter may comprise a transmitting throughput (such as uplink throughput) and a receiving throughput (such as downlink throughput).

The wireless device 300 (such as processor circuitry 302) is configured to determine, based on the cellular parameter and the network parameter, a second energy parameter. As used herein, a second energy parameter can be seen as a parameter, based on characteristics of a communication cell and of network data transmission conditions, representative of an amount of energy required for performing a communic ation of data, such as upcoming communication of data. The second energy parameter may provide for an estimation of an amount of energy required for performing a communication of data after data transmission has been performed. In some examples, the second energy parameter is determined based on the network parameter and the cellular parameter having the same value used for the determination of the first energy cost parameter.

In one or more example wireless devices, the amount of energy required for performing a communication of data may correspond to a communication cost. The communication cost may comprise a transmission cost and a reception cost. The transmission cost may cover the cost associated with the transmission of the data from the wireless device 300 to a different device, such as a server device (for example illustrated as server device 600 of FIG. 1), such as a cloud server. The reception cost may cover the cost associated with the transmission of the data from a device, such as a cloud server, to the wireless device 300. The communication cost may comprise a retransmission cost. The retransmission cost may be indicative of the cost of retransmitting the data.

In one or more example wireless devices, the first energy parameter, the second energy parameter, or both the first energy parameter and the second energy parameter comprise a plurality of energy levels. As used herein, an “energy level” can be seen as a range of energy values. For example, the energy parameter (such as the first energy parameter, the second energy parameter or both the first energy parameter and the second energy parameter) comprises a first energy level, a second energy level and a third energy level. For example, an energy level may be associated with a range of energy values. For example, the energy parameter (such as the first energy parameter, the second energy parameter or both the first energy parameter and the second energy parameter) comprises a low energy level, an intermediate energy level and a high energy level.

In one or more example wireless devices, the wireless device 300 is configured to determine, based on the cellular parameter and the network parameter, the second energy parameter using a second model. The second model may provide a correlation of the cellular parameter and the network parameter with an energy measurement measured by a power analyser. In other words, the energy measurement measured by the power analyser may be used to create the second model. Once the second model is created, the second model may be deployed in the wireless device 300 and used to determine the second energy parameter without a need for a power analyser.

In one or more example wireless devices, the second model is based on a feed forward neural network taking as input the cellular parameter and the network parameter to provide the second energy parameter. A feed forward neural network is configured to handle cellular parameter and network parameter from input node(s), and to process the information in only one direction (such as forward) from the input nodes, through the hidden nodes (if any) and to the output nodes for provision of the second energy parameter. For example, the feed forward neural network does not process in cycles or loops.

In one or more example wireless devices, the second model is based on a support vector machine (SVM). A support vector machine is for example, a supervised learning model with associated learning techniques that analyse the cellular parameter and the network parameter for classification and regression analysis. For example, given a set of training examples belonging to one of two categories, an SVM training technique builds a model that assigns new examples to one category or the other, making it a non-probabilistic binary linear classifier and/or using a probabilistic classification setting. For example, SVM maps training examples to points in space so as to maximise the width of the gap between the two categories. For example, SVM can take as input the cellular parameter and the network parameter and provide the second energy parameter.

In one or more example wireless devices, the second model is based on a random forest. For example, for classification tasks, the output of the random forest is the class (which may represent an energy level or amount of energy) predicted by a majority of the multitude of decision trees, based on the input being the cellular parameter and the network parameter. For example, for regression tasks, the mean or average prediction of the individual trees is returned as the second energy parameter based on the cellular parameter and the network parameter.

In one or more example wireless devices, the second model is based on a feed forward neural network and a support vector machine. In one or more example wireless devices, the second model is based on a feed forward neural network and a random forest. In one or more example wireless devices, the second model is based on a support vector machine and a random forest. In one or more example wireless devices, the second model is based on a feed forward neural network, a support vector machine and a random forest. The second model can be seen as a Machine Learning (ML) technique.

The second model may require an additional level of performance compared to the first model. For such reason, feed forward neural network and support vector machine may be particularly suitable as a second model.

The first model, the second model or both the first model and the second model may be trained before being deployed in the wireless device 300. The training may be carried out based on an energy measurement measured by a power analyser, such that the first model may provide a correlation between the cellular parameter and an energy measurement measured by a power analyser, and the second model may provide a correlation of the cellular parameter and the network parameter with the energy measurement measured by a power analyser. The energy measurements may be performed such that varied and balanced measurements are obtained based on one or more aspects associate with a specific environment, within a pre-established budget. The one or more aspects may comprise one or more of: a time of the day, a geospatial location (contrasting e.g. rural and urban environments), a transportation mode, shielding and placement of the device, weather conditions and building type. For each aspect, the aim may be to broadly capture corner cases such as overpasses or building corners and varying signal conditions. Training may be performed and validated using splits of energy measurements until an adequately performing model is considered for deployment into the wireless device 300.

In one or more example wireless devices, the wireless device 300 is configured to determine an update parameter based on the second energy parameter.

In one or more example wireless devices, the wireless device 300 is configured to determine whether the update parameter meets the criterion.

The wireless device 300 (such as processor circuitry 302) is configured to, upon the update parameter meeting a criterion, the update parameter being based on the second energy parameter, update the first energy parameter based on the second energy parameter and the cellular parameter. For example, the update parameter is based on the second energy parameter. For example, the wireless device 300 updates the first energy parameter based on the second energy parameter and the cellular parameter upon determining that the update parameter meets the criterion. For example, the wireless device 300 updates the first energy parameter based on the second energy parameter and the cellular parameter when it is determined that the update parameter meets the criterion.

Hence, the estimation of the amount of energy required for performing a communication of data may be refined after the data is transmitted. The update parameter may be useful to establish a criterion according to which the first energy parameter is updated. For example, the first energy parameter, which is updated based on the second energy parameter and the cellular parameter, can be used to improve the determination of the amount of energy required for performing an upcoming communication of data. In other words, for example, the updated first energy parameter is considered along the cellular parameter for the determination of the amount of energy required for performing an upcoming communication of data. When such criterion is met, the wireless device 300 may update the first energy parameter, which is then based not only on the cellular parameter but also on the second energy parameter. The first energy parameter may thus be refined. Put another way, the second energy parameter may be used as ground truth for the first energy parameter.

The wireless device 300 is configured to, upon the update parameter not meeting the criterion, not update the first energy parameter. For example, the wireless device 300 might not use the update parameter to update the first energy parameter based on the second energy parameter and the cellular parameter upon determining that the update parameter does not meet the criterion. For example, the wireless device 300 does not update the first energy parameter based on the second energy parameter and the cellular parameter upon determining that the update parameter does not meet the criterion. The wireless device 300 might not update the first energy parameter based on the second energy parameter and the cellular parameter when it is determined that the update parameter does not meet the criterion.

In one or more example wireless devices, the update parameter comprises the second energy parameter. The update parameter may be the second energy parameter. The update parameter may comprise a difference between the first energy parameter and the second energy parameter.

In one or more example wireless devices, the criterion is based on a threshold. The threshold may be a first threshold. In one or more examples, the update parameter meets the criterion when the difference between the first energy parameter and the second energy parameter is greater than the first threshold.

In one or more example wireless devices, the update parameter comprises a confidence score of the second energy parameter.

As used herein, “confidence score” can denote a probability for a particular data item to belong to a particular class. The confidence score can be softmax score in a neural network or a weighted measure of distance to clusters in a clustering algorithm.

In one or more example wireless devices, the threshold is a second threshold. In one or more examples, the update parameter meets the criterion when the confidence score of the second energy parameter is greater than the second threshold.

In one or more example wireless devices, the update parameter comprises a number of data sets for an update for an environment. As used herein, “number of data sets” may defined as the number of determinations of the second energy parameter within a certain time interval.

This type of update parameter may allow that the first energy parameter is not updated for every determination of the second energy parameter, which would be too frequent and would probably lead to minor improvements. In other words, an update parameter comprising a maximum number of data sets may ensure that the first energy parameter is no longer updated when sufficient updates have been made.

In one or more example wireless devices, the update parameter meets the criterion when the number of data sets is equal to or greater than a minimum number of data sets and equal to or less than a maximum number of data sets.

In one or more example wireless devices, the wireless device 300 is configured to transmit, upon the first energy parameter meeting a condition, the data. In one or more example wireless devices, the wireless device 300 is configured to transmit the data regardless of the first energy parameter not meeting the condition.

When the wireless device 300 is configured to transmit, upon the first energy parameter meeting a condition, the data, the wireless device 300 may comprise a scheduling component, such as a scheduler. The scheduler may be configured to determine whether the condition is met. For example, the scheduler may be configured to determine whether the amount of energy required for performing a communication of data is acceptable, that is, equal to or below a pre-established threshold of amount of energy.

Other elements of the wireless device 300 may also be configured to determine whether the condition is met. For example, the wireless device 300 may comprise a timer configured to determine whether the condition is met based on one or more of: a timeout parameter and a forecasted transmission parameter.

Processor circuitry 302 is optionally configured to perform any of the operations disclosed in FIG. 3 (such as any one or more of S102, S104, S104A, S106, S108, S110, S110A, S112, S114, S116). The processor circuitry 302 is optionally configured to perform any of the operations, such as method steps, disclosed herein. The operations of the wireless device 300 may be embodied in the form of executable logic routines (for example, lines of code, software programs, etc.) that are stored on a non-transitory computer readable medium (for example, memory circuitry 301) and are executed by processor circuitry 302.

Furthermore, the operations of the wireless device 300 may be considered a method that the wireless device 300 is configured to carry out. Also, while the described functions and operations may be implemented in software, such functionality may also be carried out via dedicated hardware or firmware, or one or more of: hardware, firmware, and software.

Memory circuitry 301 may be one or more of: a buffer, a flash memory, a hard drive, a removable media, a volatile memory, a non-volatile memory, a random-access memory (RAM) and any other suitable device. In a typical arrangement, memory circuitry 301 may include a non-volatile memory for long term data storage and a volatile memory that functions as system memory for processor circuitry 302. Memory circuitry 301 may exchange data with processor circuitry 302 over a data bus. Control lines and an address bus between memory circuitry 301 and processor circuitry 302 also may be present (not shown in FIG. 2). Memory circuitry 301 is considered a non-transitory computer readable medium.

Memory circuitry 301 may be configured to store the control signalling in a part of the memory.

FIG. 3 shows a flow diagram of an example method 100, performed by a wireless device according to the disclosure. The wireless device is the wireless device disclosed herein, such as wireless device 300 of FIG. 1, and FIG. 2.

In one or more example methods, the method 100 comprises obtaining S102 a cellular parameter indicative of cellular channel quality.

In one or more example methods, the cellular parameter includes one or more of: a signal strength, a signal to noise ratio, a bit error rate, a timing advance and a size of data to be transmitted and any other suitable cellular parameter.

In one or more example methods, the method 100 comprises determining S104, based on the cellular parameter, a first energy parameter indicative of an amount of energy required for performing a communication of data.

In one or more example methods, determining S104, based on the cellular parameter, the first energy parameter comprises using S104A a first model. In one or more example methods, the first model provides a correlation between the cellular parameter and an energy measurement measured by a power analyser.

In one or more example methods, the first model is a feed forward neural network. In one or more example wireless devices, the first model is a support vector machine. In one or more example wireless devices, the first model is a random forest. In one or more example wireless devices, the first model is a feed forward neural network and a support vector machine. In one or more example wireless devices, the first model is a feed forward neural network and a random forest. In one or more example wireless devices, the first model is a support vector machine and a random forest. In one or more example wireless devices, the first model is a feed forward neural network, a support vector machine and a random forest.

In one or more example methods, the method 100 comprises transmitting S106 the data.

In one or more example methods, transmitting S106 the data comprises transmitting the data upon the first energy parameter meets a condition.

In one or more example methods, the method 100 comprises obtaining S108 a network parameter indicative of a network condition in which the transmission of the data occurred.

In one or more example methods, the at least one network parameter comprises one or more of: a duration of transmission of the data, a number of retransmissions of the data, a throughput parameter and an uplink quality of transmission of the data, a number of transport blocks (TBs) received with cyclic redundancy check (CRC) error, a transmitting or receiving Modulation and Coding Scheme (MCS) parameter and any other suitable network parameter.

In one or more example methods, the method 100 comprises determining S110, based on the cellular parameter and the network parameter, a second energy parameter.

In one or more example methods, the first energy parameter, the second energy parameter, or both the first energy parameter and the second energy parameter comprise a plurality of energy levels.

In one or more example methods, determining S110, based on the cellular parameter and the network parameter, the second energy parameter comprises using S110A a second model. In one or more example methods, the second model provides a correlation of the cellular parameter and the network parameter with an energy measurement measured by a power analyser.

In one or more example methods, the second model is a feed forward neural network. In one or more example wireless devices, the second model is a support vector machine. In one or more example wireless devices, the second model is a random forest. In one or more example wireless devices, the second model is a feed forward neural network and a support vector machine. In one or more example wireless devices, the second model is a feed forward neural network and a random forest. In one or more example wireless devices, the second model is a support vector machine and a random forest. In one or more example wireless devices, the second model is a feed forward neural network, a support vector machine and a random forest.

In one or more example methods, the method 100 comprises, upon an update parameter meeting a criterion, the update parameter being based on the second energy parameter, updating S114 the first energy parameter based on the second energy parameter and the cellular parameter.

In one or more example methods, the method 100 comprises, upon the update parameter not meeting the criterion, not updating S116 the first energy parameter based on the second energy parameter and the cellular parameter.

In one or more example methods, the method 100 comprises determining S112 whether the update parameter meets the criterion.

In one or more example methods, the update parameter comprises the second energy parameter. In one or more example methods, the update parameter comprises a difference between the first energy parameter and the second energy parameter.

In one or more example methods, the criterion is based on a threshold. In one or more example methods, the threshold is a first threshold. In one or more example methods, the update parameter meets the criterion when the difference between the first energy parameter and the second energy parameter is greater than the first threshold.

In one or more example methods, the update parameter comprises a confidence score of the second energy parameter.

In one or more example methods, the threshold is a second threshold. In one or more example methods, the update parameter meets the criterion when the confidence score of the second energy parameter is greater than the second threshold.

In one or more example methods, the update parameter comprises a number of data sets for an update for an environment.

In one or more example methods, the update parameter meets the criterion when the number of data sets is equal to or greater than a minimum number of data sets and equal to or less than a maximum number of data sets.

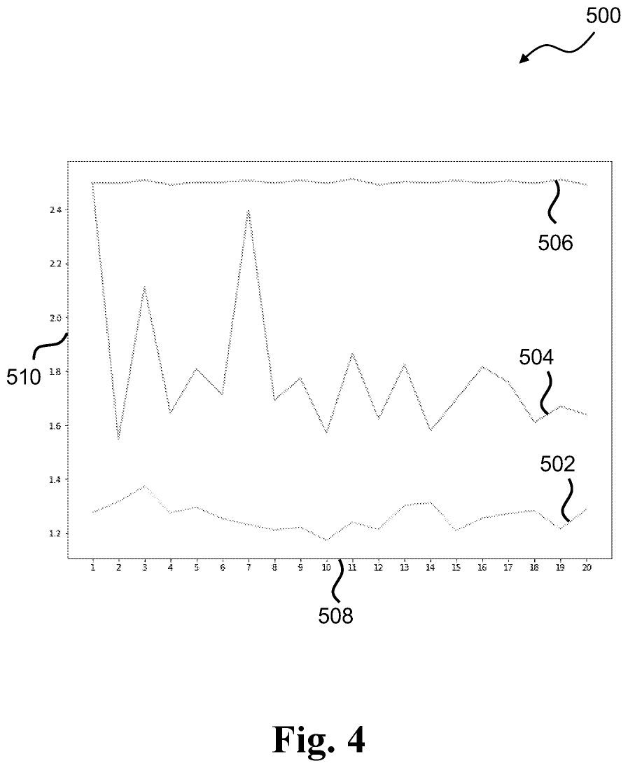

FIG. 4 shows a graph 500 illustrating a mean average error 510 of the amount of energy required for performing a communication of data as indicated by the first energy parameter and the second energy parameter compared to the amount of energy measured by a power analyser. The horizontal axis 508 shows the number of determinations of the second energy parameter.

Line 506 shows the mean average error 510 in the determination of the amount of energy by means of the first energy parameter when this parameter is not updated based on the second energy parameter. Line 502 shows the mean average error 510 in the determination of the amount of energy by means of the second energy parameter. Since the second energy parameter is based, in addition to the cellular parameter, on the network parameter, the mean average error is substantially lower than that illustrated in line 506.

Line 504 shows the mean average error 510 in the determination of the amount of energy by means of the first energy parameter when this parameter is updated based on the second energy parameter. It is noted that the first energy parameter associated with line 504 need not be updated for every determination of the second energy parameter. It can be appreciated that the mean average error 510 indicated by line 504 is lower than that indicated by line 506 after a first update of the first energy parameter takes place. The updated first energy parameter may provide a satisfactory indication of the amount of energy required for performing a communication of data before the actual communication of data associated to a certain determination of the second energy parameter.

Examples of methods and devices (wireless device) according to the disclosure are set out in the following items:

Item 1. A wireless device comprising memory circuitry, processor circuitry, and a wireless interface, wherein the wireless device is configured to:
obtain a cellular parameter indicative of cellular channel quality;
determine, based on the cellular parameter, a first energy parameter indicative of an amount of energy required for performing a communication of data;
transmit the data;
obtain a network parameter indicative of a network condition in which the transmission of the data occurred;
determine, based on the cellular parameter and the network parameter, a second energy parameter;
upon an update parameter meeting a criterion, the update parameter being based on the second energy parameter, update the first energy parameter based on the second energy parameter and the cellular parameter.

Item 2. The wireless device of item 1, wherein the wireless device is configured to:
determine, based on the cellular parameter, the first energy parameter using a first model that provides a correlation between the cellular parameter and an energy measurement measured by a power analyser.

Item 3. The wireless device of item 2, wherein the first model is one or more of: a feed forward neural network, a support vector machine and a random forest.

Item 4. The wireless device according to any one of items 1 to 3, wherein the wireless device is configured to:
determine, based on the cellular parameter and the network parameter, the second energy parameter using a second model that provides a correlation of the cellular parameter and the network parameter with an energy measurement measured by a power analyser.

Item 5. The wireless device of item 4, wherein the second model is one or more of: a feed forward neural network, a support vector machine, and a random forest.

Item 6. The wireless device according to any one of items 1 to 5, wherein the wireless device is configured to determine whether the update parameter meets the criterion.

Item 7. The wireless device according to any one of items 1 to 6, wherein the update parameter comprises the second energy parameter.

Item 8. The wireless device according to item 7, wherein the update parameter comprises a difference between the first energy parameter and the second energy parameter.

Item 9. The wireless device according to any one of items 1 to 8, wherein the criterion is based on a threshold.

Item 10. The wireless device according to items 8 and 9, wherein the threshold is a first threshold, and wherein the update parameter meets the criterion when the difference between the first energy parameter and the second energy parameter is greater than the first threshold.

Item 11. The wireless device according to any one of items 1 to 10, wherein the update parameter comprises a confidence score of the second energy parameter.

Item 12. The wireless device according to item 11 when depending on item 9, wherein the threshold is a second threshold, and wherein the update parameter meets the criterion when the confidence score of the second energy parameter is greater than the second threshold.

Item 13. The wireless device according to any one of items 1 to 12, wherein the update parameter comprises a number of data sets for an update for an environment.

Item 14. The wireless device according to item 13, wherein the update parameter meets the criterion when the number of data sets is equal to or greater than a minimum number of data sets and equal to or less than a maximum number of data sets.

Item 15. The wireless device according to any one of items 1 to 14, wherein the wireless device is configured to transmit, upon the first energy parameter meeting a condition, the data.

Item 16. The wireless device according to any one of items 1 to 15, wherein the cellular parameter includes one or more of: a signal strength, a signal to noise ratio, a bit error rate, a timing advance and a size of data to be transmitted.

Item 17. The wireless device according to any one of items 1 to 16, wherein the at least one network parameter comprises one or more of: a duration of transmission of the data, a number of retransmissions of the data, a throughput parameter and an uplink quality of transmission of the data.

Item 18. The wireless device according to any one of items 1 to 17, wherein the first energy parameter, the second energy parameter, or both the first energy parameter and the second energy parameter comprise a plurality of energy levels.

Item 20. A method, performed by a wireless device, wherein the method comprises:
obtaining (S102) a cellular parameter indicative of cellular channel quality;
determining (S104), based on the cellular parameter, a first energy parameter indicative of an amount of energy required for performing a communication of data;
transmitting (S106) the data;
obtaining (S108) a network parameter indicative of a network condition in which the transmission of the data occurred;
determining (S110), based on the cellular parameter and the network parameter, a second energy parameter;
upon an update parameter meeting a criterion, the update parameter being based on the second energy parameter, updating (S114) the first energy parameter based on the second energy parameter and the cellular parameter.

Item 21. The method of item 20, wherein determining (S104), based on the cellular parameter, the first energy parameter comprises using (S104A) a first model that provides a correlation between the cellular parameter and an energy measurement measured by a power analyser.

Item 22. The method of item 21, wherein the first model is one or more of: a feed forward neural network, a support vector machine and a random forest.

Item 23. The method according to any one of items 20 to 22, wherein determining (S110), based on the cellular parameter and the network parameter, the second energy parameter comprises using (S110A) a second model that provides a correlation of the cellular parameter and the network parameter with an energy measurement measured by a power analyser.

Item 24. The method of item 23, wherein the second model is one or more of: a feed forward neural network, a support vector machine, and a random forest.

Item 25. The method according to any one of items 20 to 24, wherein the method comprises:
determining (S112) whether the update parameter meets the criterion.

Item 26. The method according to any one of items 20 to 25, wherein the update parameter comprises the second energy parameter.

Item 27. The method according to item 26, wherein the update parameter comprises a difference between the first energy parameter and the second energy parameter.

Item 28. The method according to any one of items 20 to 27, wherein the criterion is based on a threshold.

Item 29. The method according to items 27 and 28, wherein the threshold is a first threshold, and wherein the update parameter meets the criterion when the difference between the first energy parameter and the second energy parameter is greater than the first threshold.

Item 30. The method according to any one of items 20 to 29, wherein the update parameter comprises a confidence score of the second energy parameter.

Item 31. The method according to item 30 when depending on item 28, wherein the threshold is a second threshold, and wherein the update parameter meets the criterion when the confidence score of the second energy parameter is greater than the second threshold.

Item 32. The method according to any one of items 20 to 31, wherein the update parameter comprises a number of data sets for an update for an environment.

Item 33. The method according to item 32, wherein the update parameter meets the criterion when the number of data sets is equal to or greater than a minimum number of data sets and equal to or less than a maximum number of data sets.

Item 34. The method according to any one of items 20 to 33, wherein transmitting (S106) the data comprises transmitting the data upon the first energy parameter meets a condition.

Item 35. The method according to any one of items 20 to 34, wherein the cellular parameter includes one or more of: a signal strength, a signal to noise ratio, a bit error rate, a timing advance and a size of data to be transmitted.

Item 36. The method according to any one of items 20 to 35, wherein the at least one network parameter comprises one or more of: a duration of transmission of the data, a number of retransmissions of the data, a throughput parameter and an uplink quality of transmission of the data.

Item 37. The method according to any one of items 20 to 36, wherein the first energy parameter, the second energy parameter, or both the first energy parameter and the second energy parameter comprise a plurality of energy levels.

The use of the terms “first” and “second; “primary”, “secondary”, etc. does not imply any particular order (let alone a specific spatial or temporal order, or an order of importance). Rather the reverse, the terms “first”, “second”; “primary”, “secondary”, etc. are included to identify individual elements, that is, they are provided for labelling purposes with an aim to distinguish elements from each other. Furthermore, the labelling of a first element does not imply the presence of a second element and vice versa.

It may be appreciated that the figures comprise some circuitries, components, features or operations which are illustrated with a solid line and some circuitries, components, features or operations which are illustrated with a dashed line. Circuitries, components, features or operations which are delimited by a solid line are circuitries, components, features or operations which are comprised in the broadest example of an exemplary embodiment. Circuitries, components, features or operations which are delimited by a dashed line are examples which may be comprised in, or a part of, or are further circuitries, components, features or operations which may be taken in addition to circuitries, components, features, or operations of the broadest example represented by the solid line. It should be appreciated that these operations need not be performed in the presented order. The example operations may be performed in any order and in any combination. Furthermore, it should be appreciated that not all of the operations need be performed.

Other operations that are not described herein can be incorporated in the example operations. For example, one or more additional operations can be performed before, after, simultaneously or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” “features” or “devices” may be represented by the same item of hardware.

Language of degree used herein, such as the terms “approximately,” “about,” “generally” and “substantially”, represent a value, amount or characteristic close to the stated value, amount or characteristic that still performs a desired function or achieves a desired result. For example, the terms “approximately”, “about”, “generally” and “substantially” may refer to an amount that is: within less than or equal to 10% of, within less than or equal to 5% of, within less than or equal to 1% of, within less than or equal to 0.1% of, and within less than or equal to 0.01% of the stated amount. If the stated amount is 0 (for example, none or having no), the above recited ranges can be specific ranges instead of a particular % of the value.

The various example methods, devices, nodes, and systems described herein are described in the general context of method steps or processes, which may be implemented by a computer program product, embodied in a computer-readable medium (including computer-executable instructions, such as program code) and executed by computers in networked environments. A computer-readable medium may include removable and non-removable storage devices including, but not limited to: Read Only Memory (ROM), Random Access Memory (RAM), compact discs (CDs), digital versatile discs (DVD) and any other suitable storage device. Generally, program circuitries may include routines, programs, objects, components, data structures, etc. that perform specified tasks or implement specific abstract data types. Computer-executable instructions, associated data structures and program circuitries represent examples of program code for executing steps of the methods disclosed herein. The particular sequence of such executable instructions or associated data structures represents examples of corresponding acts for implementing the functions described in such steps or processes.

Although example features have been shown and described, it will be understood that they are not intended to limit the claims, and it will be made obvious to those skilled in the art that various changes and modifications may be made without departing from the scope of the claims. The specification and drawings are, accordingly, to be regarded in an illustrative rather than restrictive sense. The claims are intended to cover all alternatives, modifications, and equivalents.

What is claimed is:

1. A wireless device comprising memory circuitry, processor circuitry, and a wireless interface, wherein the wireless device is configured to:
obtain a cellular parameter indicative of cellular channel quality;
determine, based on the cellular parameter, a first energy parameter indicative of an amount of energy required for performing a communication of data;
transmit the data;
obtain a network parameter indicative of a network condition in which the transmission of the data occurred;
determine, based on the cellular parameter and the network parameter, a second energy parameter;
upon an update parameter meeting a criterion, the update parameter being based on the second energy parameter, update the first energy parameter based on the second energy parameter and the cellular parameter.

2. The wireless device according to claim 1, wherein the wireless device is configured to:
determine, based on the cellular parameter, the first energy parameter using a first model that provides a correlation between the cellular parameter and an energy measurement measured by a power analyser.

3. The wireless device according to claim 2, wherein the first model is one or more of: a feed forward neural network, a support vector machine and a random forest.

4. The wireless device according to claim 1, wherein the wireless device is configured to:
determine, based on the cellular parameter and the network parameter, the second energy parameter using a second model that provides a correlation of the cellular parameter and the network parameter with an energy measurement measured by a power analyser.

5. The wireless device according to claim 4, wherein the second model is one or more of: a feed forward neural network, a support vector machine, and a random forest.

6. The wireless device according to claim 1, wherein the wireless device is configured to determine whether the update parameter meets the criterion.

7. The wireless device according to claim 1, wherein the update parameter comprises the second energy parameter.

8. The wireless device according to claim 7, wherein the update parameter comprises a difference between the first energy parameter and the second energy parameter.

9. The wireless device according to claim 1, wherein the criterion is based on a threshold.

10. The wireless device according to claim 8, wherein the threshold is a first threshold, and wherein the update parameter meets the criterion when the difference between the first energy parameter and the second energy parameter is greater than the first threshold.

11. The wireless device according to claim 1, wherein the update parameter comprises a confidence score of the second energy parameter.

12. The wireless device according to claim 11 when depending on item 9, wherein the threshold is a second threshold, and wherein the update parameter meets the criterion when the confidence score of the second energy parameter is greater than the second threshold.

13. The wireless device according to claim 1, wherein the update parameter comprises a number of data sets for an update for an environment.

14. The wireless device according to claim 13, wherein the update parameter meets the criterion when the number of data sets is equal to or greater than a minimum number of data sets and equal to or less than a maximum number of data sets.

15. The wireless device according to claim 1, wherein the wireless device is configured to transmit, upon the first energy parameter meeting a condition, the data.

16. The wireless device according to claim 1, wherein the cellular parameter includes one or more of: a signal strength, a signal to noise ratio, a bit error rate, a timing advance and a size of data to be transmitted.

17. The wireless device according to claim 1, wherein the at least one network parameter comprises one or more of: a duration of transmission of the data, a number of retransmissions of the data, a throughput parameter and an uplink quality of transmission of the data.

18. The wireless device according to claim 1, wherein the first energy parameter, the second energy parameter, or both the first energy parameter and the second energy parameter comprise a plurality of energy levels.

19. A method, performed by a wireless device, wherein the method comprises:
obtaining a cellular parameter indicative of cellular channel quality;
determining, based on the cellular parameter, a first energy parameter indicative of an amount of energy required for performing a communication of data;
transmitting the data;
obtaining a network parameter indicative of a network condition in which the transmission of the data occurred;
determining, based on the cellular parameter and the network parameter, a second energy parameter;
upon an update parameter meeting a criterion, the update parameter being based on the second energy parameter, updating the first energy parameter based on the second energy parameter and the cellular parameter.
